(19) United States
(12) Patent Application Publication
(10) Pub. No.: US 2008/0212111 A1
(43) Pub. Date: Sep. 4, 2008

(54) DOCUMENT DISCARDING PROCESS SYSTEM, DISCARD DOCUMENT MANAGEMENT DEVICE, DOCUMENT PROCESSING DEVICE, DOCUMENT DISCARDING PROCESSING METHOD AND RECORDING MEDIUM STORING DOCUMENT DISCARDING PROCESSING PROGRAM

(75) Inventor: Yoshihiro Masuda, Ashigarakami-gun (JP)

Correspondence Address: SUGHRUE MION, PLLC, 2100 PENNSYLVANIA AVENUE, N.W., SUITE 800, WASHINGTON, DC, 20037, US

(73) Assignee: FUJI XEROX CO., LTD., Tokyo (JP)

(21) Appl. No.: 11/876,128

(22) Filed: Oct. 22, 2007

(30) Foreign Application Priority Data
Mar. 2, 2007 (JP) 2007-52896

(51) Int. Cl. G06F 15/00

(52) U.S. Cl. 358/1.9

(57) ABSTRACT

A document discarding process system, which includes a discard document management device that registers and manages a discard target document to be discarded; and at least one document processing device that is connected to the discard document management device through a communication section, the discard document management device, which includes an accepting section that accepts a registration of the discard target document; a registering section that registers the accepted discard target document; and a distributing section that distributes identification information for identifying the registered discard target document through the communication section to the at least one document processing device, and the at least one document processing device, which includes: a receiving section that receives the distributed identification information; a searching section that searches the discard target document based on the received identification information; and a discarding section that discards the searched discard target documents.

### CROSS-REFERENCE TO RELATED APPLICATION

This application is based on and claims priority under 35 USC 119 from Japanese Patent Application No. 2007-52896 filed on Mar. 2, 2007.

### BACKGROUND

1. Technical Field

The present invention relates to a document discarding process system, a discard document management device, a document processing device, a document discarding processing method, and a recording medium storing a document discarding processing program.

2. Related Art

Recently, there have been proposed various techniques for enhancing the safety of confidential information in response to the enforcement of the Act on the Protection of Personal Information. Especially, under a situation where the confidential information is easily carried, for example, when the mobile terminal that has excellent portability is used or when documents are printed out, there is a high possibility of occurrence of information leakage. As a result, higher safety is required.

### SUMMARY

An aspect of the present invention provides a document discarding process system, which includes a discard document management device that registers and manages a discard target document to be discarded; and at least one document processing device that is connected to the discard document management device through a communication section, the discard document management device, which includes: an accepting section that accepts a registration of the discard target document; a registering section that registers the discard target document that is accepted by the accepting section; and a distributing section that distributes identification information for identifying the discard target document registered by the registering section through the communication section to the at least one document processing device, and the at least one document processing device, which includes: a receiving section that receives the identification information distributed by the distributing section; a searching section that searches the discard target document based on the identification information received by the receiving section; and a discarding section that discards the discard target documents searched by the searching section.

### BRIEF DESCRIPTION OF THE DRAWINGS

An exemplary embodiment of the present invention will be described in detail based on the following figures, wherein:

FIG. 1 is an example system configuration diagram showing a document discarding process system configured by applying a document discarding process system, a discard document management device, a document processing device, a document discarding processing method, and a recording medium storing a document discarding processing program pertaining to the present invention;

FIG. 2 is a block diagram showing a detailed configuration of the document discarding process system pertaining to the present invention;

FIG. 3 shows an example of a display for designating a document to be discarded;

FIG. 4 is a diagram showing a list of documents that can be designated as being discarded;

FIG. 5 is a diagram showing a display for setting a display condition in which an operation history of a document designated as being discarded is illustrated;

FIG. 6 is a sequential diagram showing a transition of a process pertaining to the present invention;

FIG. 7 is an example of a flowchart showing a process flow for registering the operation history to an operation history management server through a process by a client PC;

FIG. 8 is an example of a flowchart showing a process flow in a case where a document ID is configured from a hash value calculated by applying the hash function to a document;

FIG. 9 is an example of a flowchart showing a process for registering the operation history in accordance with a communication state between the client PC and the operation history management server;

FIG. 10 is an example of a flowchart showing a process flow for designating a document to be discarded using the client PC;

FIG. 11 is an example of a flowchart showing a flow of registration process in which the document management server performs registration to the discarding document list in response to the request for discarding processing from the client PC as shown in FIG. 10;

FIG. 12 is an example of a flowchart showing a process flow for discarding a document indicated on a discarding document list in a document management server;

FIGS. 13A to 13E are diagrams showing an example of the discarding document list using the Bloom Filter;

FIG. 14 is another sequence diagram showing a transition of a process pertaining to the present invention;

FIGS. 15A to 15C are diagrams explaining the Bloom Filter;

FIG. 16 is an example of a flowchart showing a process flow of creating a bloom filter in the document management server based on the Bloom Filter;

FIG. 17 is an example of a flowchart showing a flow of discarding processing in the client PC;

FIG. 18 is an example of a flowchart showing a process flow for determining in the document management server whether a document is to be discarded or not;

FIG. 19 is an example of another system configuration diagram showing a document discarding process system configured by applying the document discarding process system and the program pertaining to the present invention; and

FIG. 20 is an example of a flowchart showing a process flow performed by a device having a code reader.

### DETAILED DESCRIPTION

Hereinbelow, a detailed description will be made of examples of a document discarding process system, a discard document management device, a document processing device, a document discarding processing method, and a recording medium storing a document discarding processing program pertaining to the present invention with reference to the attached drawings.

It should be noted that, in the following exemplary description, plural devices are separately used. However, the present invention is not limited to this, and may be configured in one and the same device so as to realize the document processing.

### FIRST EXAMPLE

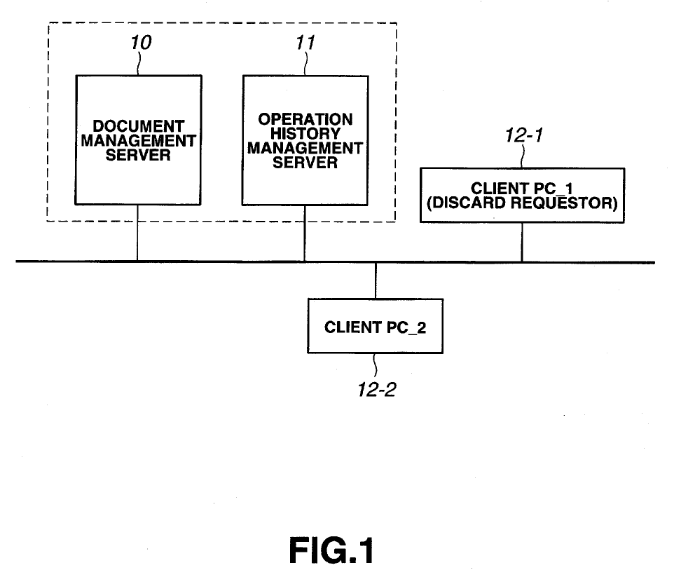

FIG. 1 is an example system configuration diagram showing a document discarding process system configured by applying a document discarding process system, a discard document management device, a document processing device, a document discarding processing method, a recording medium storing a document discarding processing program pertaining to the present invention.

In the document discarding process system as shown in FIG. 1, a document management server 10, an operation history management server 11, a client PC 1 12-1, a client PC 2 12-2 (hereinafter the client PC 1 12-1 and the client PC 2 12-2 are collectively referred to as “client PC 12”) are connected in a state where those can be communicated each other through a communication line, wireless communication, or other communication means. And, the document discarding process system is a system for discarding (deleting) an electronic document (hereinafter referred to as “document”) in the client PC 12.

This discarding process is a process in which the discarded document cannot be recovered or reproduced in the client PC 12. Unlike the general process in which the document is moved to the evacuation area so-called “Trash”, the document itself is discarded in this discarding process.

The document management server 10 manages a document operable in the client PC 12. Histories of operations for all the documents managed by the document management server 10 are managed by the operation history management server 11. And, upon operation of a document using the client PC 12, the history of operations is updated.

The operations include updating, discarding, printing, downloading, copying the document, and so on. Using the managed history of operations, documents (hereinafter referred to as “derived document”) derived as a result of those operations for the original documents can be managed.

In other words, by designating the original document, the derived document can be identified with the original document, enabling the derived document to be discarded.

Additionally, the document management server 10 manages a “discarding document list”, which forms a list of documents to be discarded from documents in the client PC 12. In this discarding document list, a document to be discarded from the system is designated using document identifying information (hereinafter referred to as “document ID”) that uniquely identifies the document or the Bloom Filter. An example for a case where the Bloom Filter is used will be described in the Second Example.

The operation history management server 11 manages the history of operations of the document operated through the client PC 12, and integratedly manages the histories of operations for documents that are decentralized in plural client PCs 12 (client PC 1 12-1, client PC 2 12-2). By referring to the managed histories of operations at the time of discarding the document in the discarding document list managed by the document management server 10, each of the documents derived from the document designated as being discarded can also be discarded.

The client PC 12 can download and operate the document managed by the document management server 10. Additionally, the client PC 12 can newly create and operate a document using a prescribed application.

Each of the client PCs 12 has a document operation detecting function and a designated document discarding function. The content of operations performed for the document is detected by the document operation detecting function, and the detected details are managed by the operation history management server 11 as a history of operations. Additionally, the client PC 12 searches a document in the discarding document list managed by the document management server 10, and discards the matched document using the designated document discarding function.

Upon discarding the document using the designated document discarding function in the client PC 12, history information (hereinafter “discarding process history”) regarding the discarding process is created and managed in the operation history management server 11. This discarding process history may be managed as a part of the history of operations of each of the documents managed by the operation history management server 11, and may also be managed separately. In the latter case, the discarding process history is managed such that a document ID for the discarded document is associated with the date of the discard, the operator of the discard, and so on.

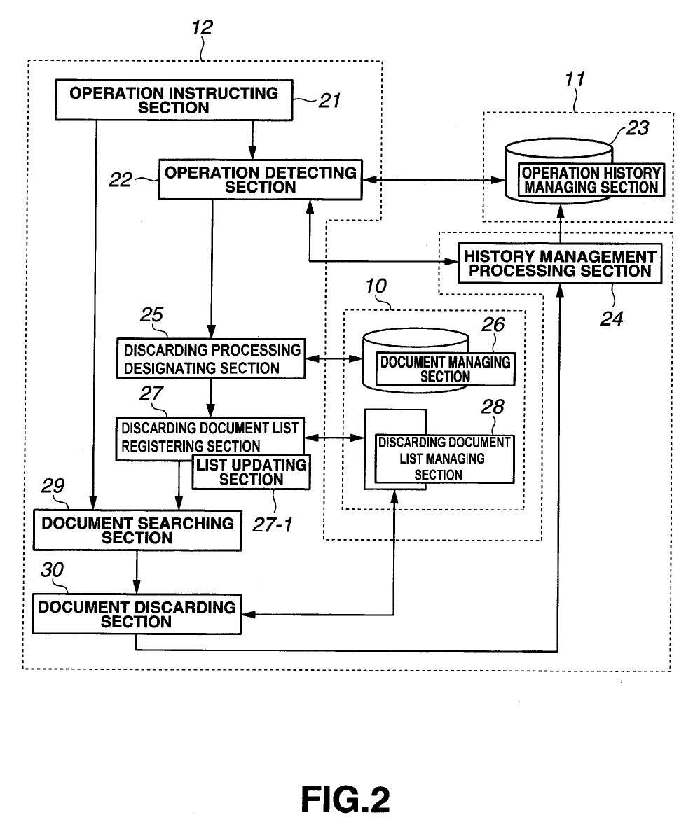

FIG. 2 is a block diagram showing a detailed configuration of the document discarding process system pertaining to the present invention.

The document discarding process system shown in FIG. 2 includes a operation instructing section 21, a operation detecting 22, a operation history managing section 23, a history management processing section 24, a discarding processing designating section 25, a document managing section 26, a discarding document list registering section 27, a discarding document list managing section 28, a document searching section 29, and a document discarding section 30. The operation history managing section 23 provides a function of the operation history management server 11 as shown in FIG. 1. The document managing section 26 and the discarding document list managing section 28 provide a function of the document management server 10 as shown in FIG. 1.

The operation instructing section 21 functions as a user interface such as display and keyboard, and the document is operated through the operation instructing section 21. The document to be operated includes a document to be managed by the document managing section 26, and a newly created document. By operating these documents using the operation instructing section 21, the operation detecting section 22 detects the content of the operation.

The operation detecting section 22 includes the document operation detecting function in the client PC 12 as shown in FIG. 1. The operation detecting section 22 detects the performed operation using the operation instructing section 21, and registers the history of operations via the history management processing section 24 to the operation history managing section 23.

The history management processing section 24 determines whether the history of operations of the operated document is registered in the operation history managing section 23, and overwrites the registered history when the history of operations is registered. On the other hand, when the history of operations of the operated document is not registered in the operation history managing section 23, for example, when the document operated by the operation instructing section 21 is a newly created document using a prescribed application, the history management processing section 24 responds to the operation detecting section 22 while attaching the document identifying information (hereinafter also referred to as “document ID”) that uniquely identifies the document, and registers the history of operations to the operation history managing section 23 as a new history of operations.

The document ID may be a hash value obtained by applying the hash function, such as “SHA-1”, to identification information generated using the random sequences or a document itself.

In a case when the hash value is used for the document ID, the hash value is managed in association with the history of operations. In this case, when an operation is performed to the document having a hash value before the operation, the operation is added to the history of operations. Then, the history of operations that includes the newly added operation is registered in association with a hash value obtained from the document after the operation. As described above, when the hash value is used for the document ID, adding the document ID to the document is not necessary.

With the configuration as described above, history of various operations instructed for the document by the operation instructing section 21 is managed by the operation history managing section 23.

Next, when the document is discarded, the discarding processing designating section 25 designates a document to be discarded. The discarding processing designating section 25 is configured with a user interface of each of the client PCs 12 as shown in FIG. 1, and so on, and designates a document to be discarded among documents in each of the client PCs 12 and documents managed in the document managing system.

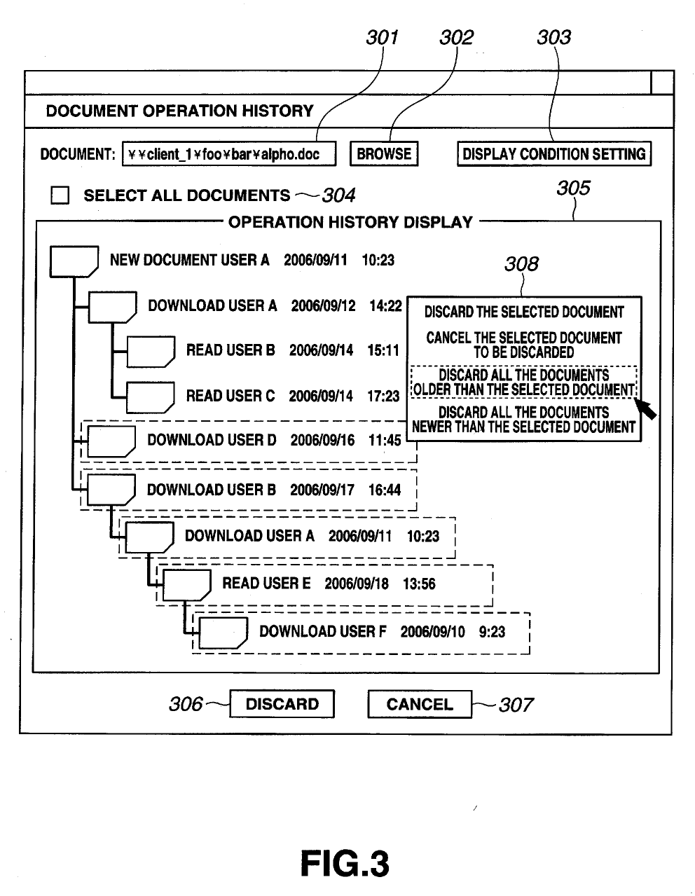

The discarding processing designating section 25 shows a display for designating a document to be discarded (hereinafter referred to as “discard target document”), and the discard target document is designated through the display. For example, a display as shown in FIG. 3 is used. The display as shown in FIG. 3 is used for designating a document indicated in the history of operations of a discard target document by designating the discard target document, and displaying the history of operations of the discard target document.

The display as shown in FIG. 3 includes a document path designating box 301, a browse button 302, a display condition setting section 303, a select all checkbox 304, a history display field 305, a discard button 306, and a cancel button 307.

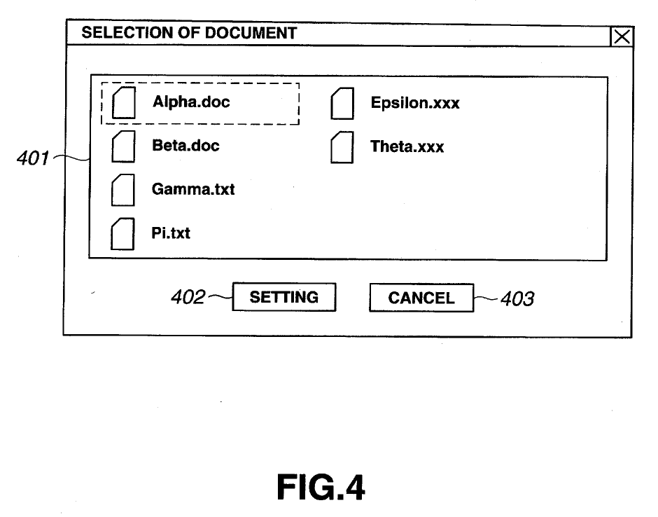

The document path designating box 301 is an item for designating a discard target document to be discarded. The discard target document can be designated by directly inputting a document path in the document path designating box 301. Additionally, the discard target document can also be designated by selecting from the displayed document list using the browse button 302. FIG. 4 is an example of the display shown by clicking the browse button 302.

FIG. 4 shows a situation in which a list of documents that can be designated as being discarded is shown in a document list field 401. The document to be discarded can be designated by selecting any of the documents and clicking a setting button 402. The designation can be canceled by clicking a cancel button 403.

FIG. 4 shows a situation in which “alpha.doc” is selected as the document to be discarded. A situation in which the setting button 402 is clicked while this document is being selected corresponds to the situation as shown in FIG. 3.

Specifically, a document indicated by “¥¥client_{—}1¥foo¥bar¥alpha.doc” in the document path designating box 301 in FIG. 3 is the document to be discarded. Additionally, the display condition setting button 303 as shown in FIG. 3 is a button for showing a display for setting a display condition at the time of showing the history of operations of the document indicated in the document path designating box 301.

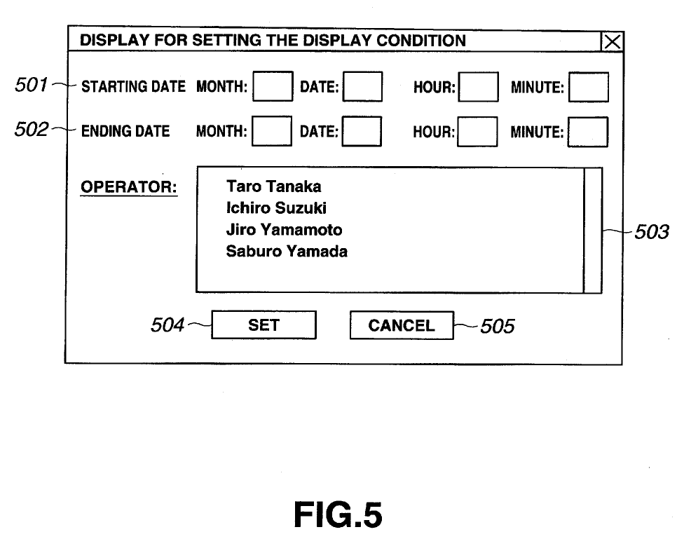

By clicking the display condition setting section 303, a display as shown in FIG. 5 is displayed.

FIG. 5 shows a display in which a display condition for displaying the history of operations of the designated discard target document is illustrated. In this display, a range of the history of operations is set using a starting date item 501 and an ending date item 502. The display shows the history of operations for the document registered during the period from the date set in the starting date item 501 to the date set in the ending date item 502.

Additionally, an operator who operates the document may be designated in an operator designating field 503 as a display condition. For these display conditions, only either one of the display conditions may be set. In the case when both of the display conditions are set, the history of operations of the document that matches the condition of the logical AND is searched.

By clicking a setting button 504 after the display condition for the history of operations is set, history of operations that matches the condition is displayed in the history display field 305 shown in FIG. 3. Incidentally, by checking the select all checkbox 304, all of the history of operations for the discard target document can be displayed.

In the history display field 305 in FIG. 3, the history of operations of the document designated in the document path designating box 301 is shown based on the display condition that is set from the display that shows up by clicking the display condition setting button 303.

The history of operations shown in FIG. 3 indicates that a newly created document is downloaded three times by different operators (User A, User D and User B in the display example in FIG. 3). And, one of the documents, which is downloaded by the User A, is read by different two operators (User B and User C in the display example in FIG. 3).

Additionally, the operation history shown in FIG. 3 also indicates that other one document (document downloaded by User B) is further downloaded by other operator (User A), and this downloaded document is read by an operator, User E. The document read by the User E is downloaded by an operator, User F.

As described above, by selecting the history of operations for the document to be discarded from the history of operations displayed in the history display field 305, and clicking the discard button 306, the document with the selected history of operations is discarded.

It should be noted that FIG. 3 shows a state where five histories of operations are selected, and those selected histories of operations are discarded by clicking the discard button 306 in this state. However, the discarding process is not limited to this. The discarding process may also be set such that discarding is performed for documents indicated by history of operations other than the selected history of operations. Furthermore, in addition to discard all the history of operations older than the selected history of operations, the discarding process may be set so as to be performed to all the history of operations newer than the selected history of operations, and the like.

The above stated conditions can be set by displaying an instructing menu 308 (generally called “contextual menu”) using a pointing device.

When a document to be discarded is designated by the discarding processing designating section 25 shown in FIG. 2 using a display as shown in FIG. 3, the discarding document list registering section 27 registers the identification information of the document to the discarding document list managed by the discarding document list managing section 28. The discarding document list managing section 28 manages the “discarding document list” that is a list for information identifying the document to be designated as being discarded. In the managed discarding document list, register time information can be set to the identification information for each of the documents.

Additionally, the discarding document list registering section 27 comprises a list updating section 27-1. The list updating section 27-1 updates the discarding document list based on the elapsed time. When a certain time period elapses from the register time of the register time information set for each of the identification information in the discarding document list, the list updating section 27-1 performs an update process by deleting from the discarding document list the identification information of the document in which the certain time period elapses.

Upon registration of the discard target document to the discarding document list, the document searching section 29 searches the document registered in the discarding document list. The document searching section 29 searches the document based on the history of operations of the document registered in the discarding document list.

When the document to be discarded is found as a result of the search described above, the document searching section 29 requests the document discarding section 30 to perform the discarding process, and the document discarding section 30 that receives the request for discarding discards the document. And, history information (“discarding process history”) of the discarding process is registered through the history management processing section 24 to the operation history managing section 23. At this time, the history management processing section 24 manages the discarding process history associated with the history of operations.

It should be noted that the history management processing section 24 identifies an administrator who manages the document registered in the discarding document list, and determines whether the document to be discarded is discarded by the document discarding section 30 without fail. Through this process, when the history management processing section 24 determines that the document is discarded without fail, the history management processing section 24 requests the list updating section 27-1 to delete the information of the document from the discarding document list.

In this case, the list updating section 27-1 performs the updating process by deleting the requested information of the document from the discarding document list managed by the discarding document list managing section 28.

With the configuration described above, the designated document and a derived document that is derived from the designated document are discarded.

It should be noted that, in the process described above, the identification information identifying the document to be discarded is deleted from the discarding document list. However, the process is not limited to this configuration. The process may also be configured such that, in place of deleting the identification information from the discarding document list, all the identification information of the document designated as being discarded is registered as the discarding document list to ensure that the document with the identification information registered in the discarding document list is discarded regardless of the process performed by the client PC thereafter.

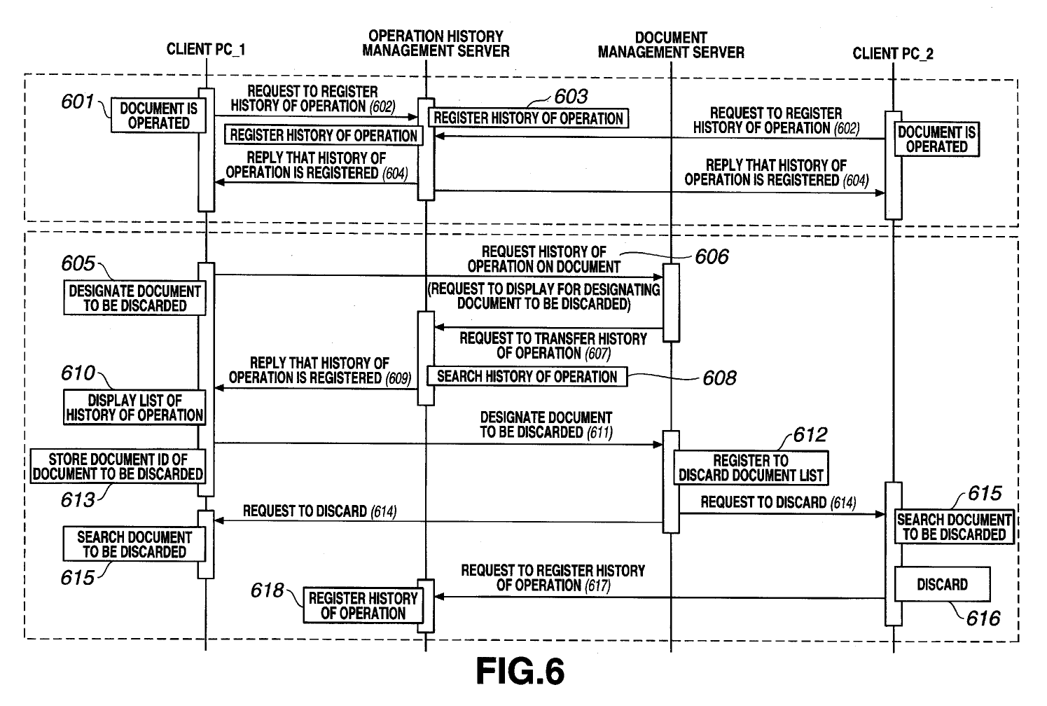

Next, FIG. 6 shows a transition of a process of the present invention with the configuration shown in FIG. 1.

FIG. 6 is a sequential diagram showing the transition of the process of the present invention. The sequential diagram shows a sequence of registering the history of operations to the operation history management server, and a sequence of discarding a document.

First, in the sequence of registering the history of operations, when the document is operated in the client PC 1 (601), the client PC 1 requests the operation history management server to register the history of the operation (602), and the operation history management server receiving the request registers the history of the operation (603). Upon completion of the registration, the operation history management server replies to the client PC 1 with the completion of the registration (604).

With the above-described process performed by each of the client PC, the histories of the operations of various documents are registered. It should be noted that FIG. 6 shows a registration process for the history of operation when the document is operated using the client PC 2.

When a document to be discarded is designated in the client PC 1 while the history of operations is registered in the operation history management server as described above (605), the client PC 1 requests the document management server to display a history of operations in connection with the document (606). In response to the request for the list, the document management server requests the operation history management server to display, in the client PC 1, the list of the related documents from the history of operations of the document (607).

The operation history management server that receives the request searches the history of the operations for the document (608), and replies to the client PC 1 with the searched history of the operations (609). The client PC 1 displays the received history of the operations (610).

In the state described above, when an operator selects the history of the operation of the document to be discarded (611), the document indicated in the selected history of the operations is registered in the discarding document list in the document management server (612). At the same time, the client PC 1 stores the document ID of the document designated as being discarded (613).

When a document is newly registered in the discarding document list, or when a certain time period elapses from the last time when the discarding process is performed, the document management server informs the client PC 1 and the client PC 2 of the request for discarding the document in the discarding document list (614).

With the process described above, each of the client PCs receiving the request for the discarding processing searches the designated document (615), and if there is any matched document, the discarding process for the matched document is performed (616). The sequence shown in FIG. 6 illustrates the case where the document to be discarded exits in the client PC 2, and the document to be discarded does not exist in the client PC 1.

The process ends in the client PC 1 that does not have the document to be discarded. Needless to say, this system may also be configured such that the client PC 1 informs the document management server that the document to be discarded does not exist.

On the other hand, after completing the document discarding process, the client PC 2 that has the document to be discarded requests the operation history management server to register the history of the operation (617), and causes the operation history management server to register the discarding process history (618).

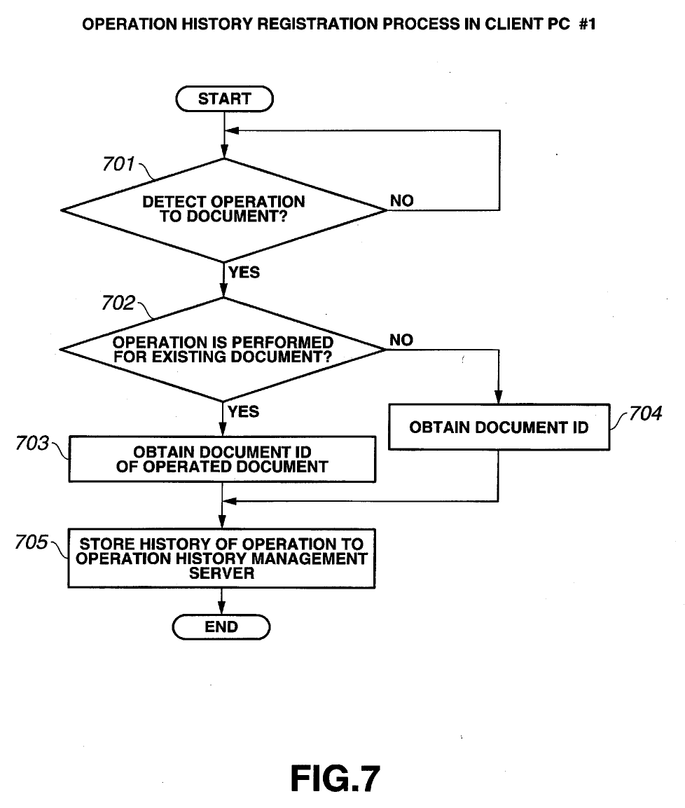

Next, a detailed process flow using each of the devices having a configuration in FIG. 1 will be described with reference to flowcharts shown in FIGS. 7 through 12.

Firstly, FIG. 7 is an example flowchart showing a process flow for registering a history of operations to the operation history management server through a process in the client PC.

When a document to be operated is designated and is operated (YES in 701), it is determined whether the document to be operated is the existing document (702). As a result of the determination, when it is determined that the document to be operated is not newly created document and that the operation is performed to the document existing in the client PC (YES in 702), the document ID attached to the document is obtained (703), and the history of the operation to the document identified by the document ID is updated and stored (705).

On the other hand, when it is determined that the document to be operated is not the existing document, but a newly created document (NO in 704), the document ID identifying the document is obtained because the history of the operation is not managed in the operation history management server (704), and the new history of the operation is registered to the operation history management server (705).

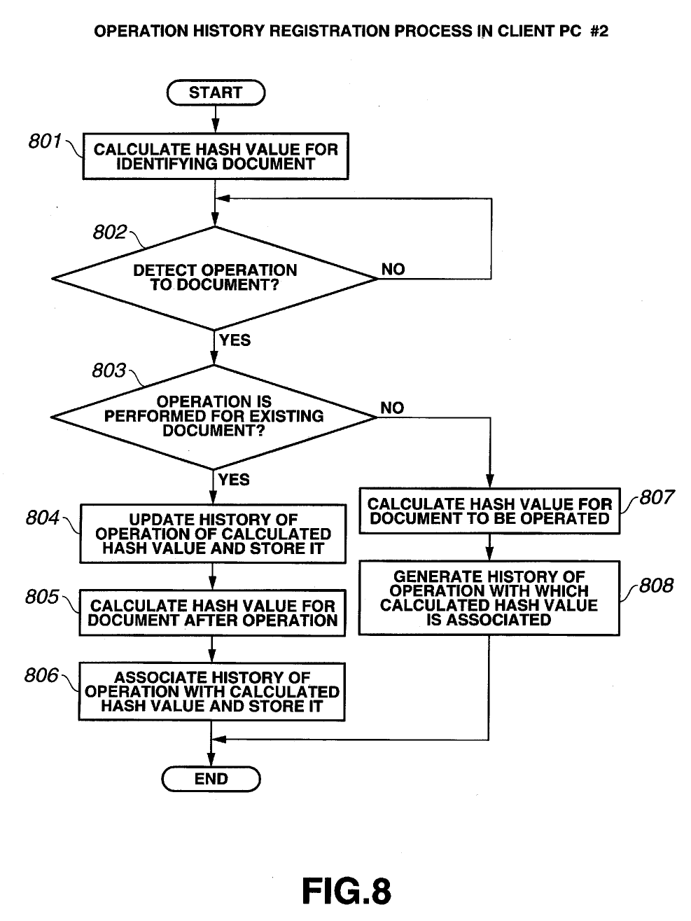

FIG. 8 shows a variation of the flowchart shown in FIG. 7.

FIG. 8 is an example flowchart showing a process flow in a case when the document ID is configured with a hash value calculated by applying the hash function to the document.

When the document is designated as being operated, a hash value for the document is calculated (801). Upon detecting that the document for which the hash value is calculated is operated (YES in 802), it is determined whether the operation is performed for the existing document (803). When it is determined that the operation is performed for the existing document (YES in 803), the history of the operation for the calculated hash value is updated and stored (804). Furthermore, by applying the hash function to the document after operation, a hash value after the operation is obtained (805), and is stored associated with the history of the operation (806).

On the other hand, when it is determined that the operation is not performed for the existing document, and the document is a newly created one (NO in 803), a hash value is calculated by applying the hash function to the newly created document (807). Accordingly, the history of the operation with which the calculated hash value is associated is generated (808).

Through the process shown in the flowcharts in FIGS. 7 and 8, the history of the operations for the document is registered.

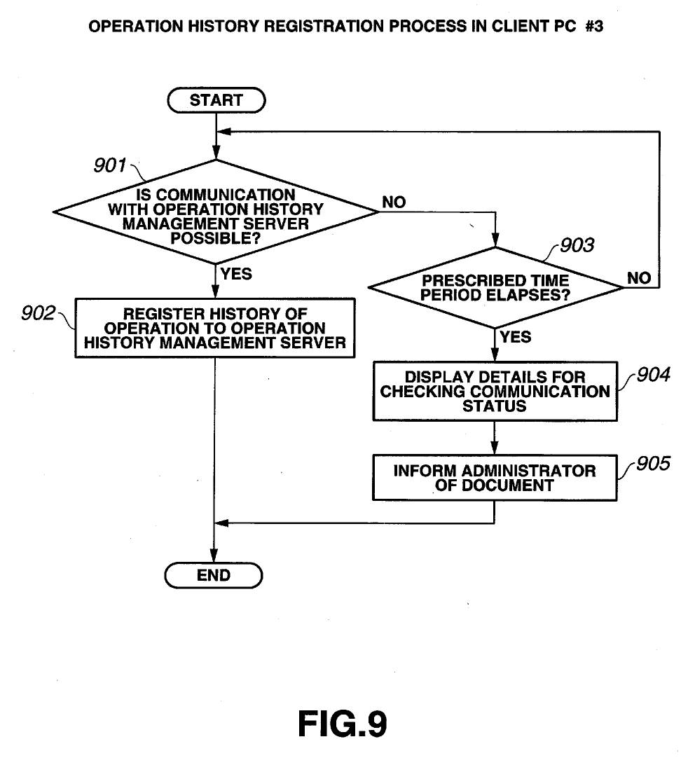

Next, FIG. 9 is an example flowchart showing a registration process flow for the history of operation in accordance with the communication status between the client PC and the operation history management server.

In FIG. 9, upon operation of a document, the process is activated. And, it is determined whether the communication with the operation history management server that registers the operation for the document to the history of the operation is possible (901). When it is determined that the communication is possible (YES in 901), the history of the operation is registered to the operation history management server as shown in FIGS. 7 and 8 (902).

On the other hand, when the communication with the operation history management server that registers the history of the operation is impossible (NO in 901), it is then determined whether the status where the communication is impossible continues for a prescribed time period (903). The determination process (903) for determining whether the prescribed time period elapses is performed by determining whether the prescribed time period elapses from the state where the communication becomes impossible. However, this process is not limited to this. The process may also be set to determining that, by setting the prescribed time period to “0 (zero)”, the prescribed time period already elapses from the state where the communication with the operation history management server becomes impossible, at the time of registering the history of operation.

When it is determined, by the determination process (903), that the prescribed time period does not elapse (NO in 903), the process becomes stand-by state until the prescribed time elapses. On the other hand, when the prescribed time period elapses (YES in 903), the state where the communication is impossible is shown on the display of the client PC (904), and an administrator of the document is informed of the state (905).

It should be noted that the administrator of the document requests to discard the document using a device available to communicate with the client PC, and the client PC that receives the request for discarding implements the designated document discarding function, whereby the document corresponding to the history of the operation can be discarded from the client PC.

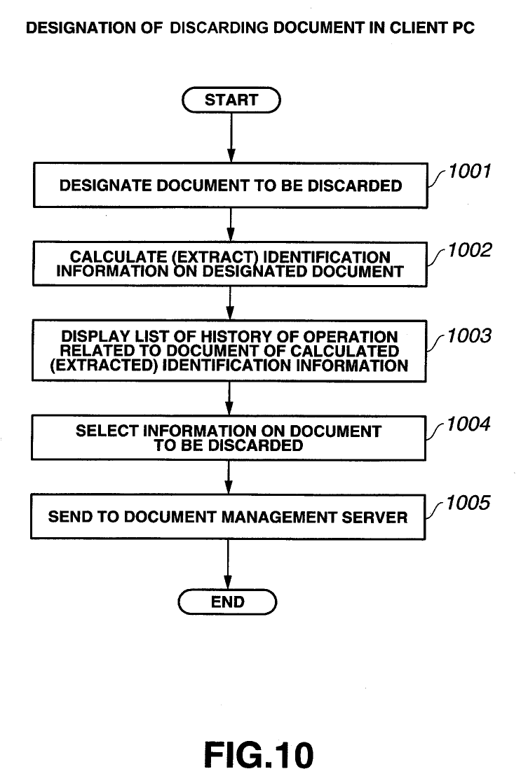

FIG. 10 is an example flowchart showing a process flow for designating a document to be discarded using the client PC.

In FIG. 10, the document to be discarded is designated using the client PC (1001), and identification information of the designated document is calculated (extracted) (1002). When the identification information is configured with a hash value, i.e. when the identification information is the hash value calculated by applying the hash function to the whole document as described above, the hash value for the operated document is calculated. Additionally, when the identification information is configured with information uniquely identifying the document, the identification information added to the document is extracted.

Next, a list of the history of the operations for the document, which relates to the document identified by the calculated (extracted) identification information, is displayed (1003). This display of the list is performed such that a request for a list of the document identified by the identification information is sent to the document management server, and the document management server sends to the client PC the history of operations corresponding to the identification information, which is held in the operation history management server.

A history of operations for the document to be discarded is selected from the displayed history of operations (1004), and a request for discarding the document corresponding to the selected history of operation is sent to the document management server (1005).

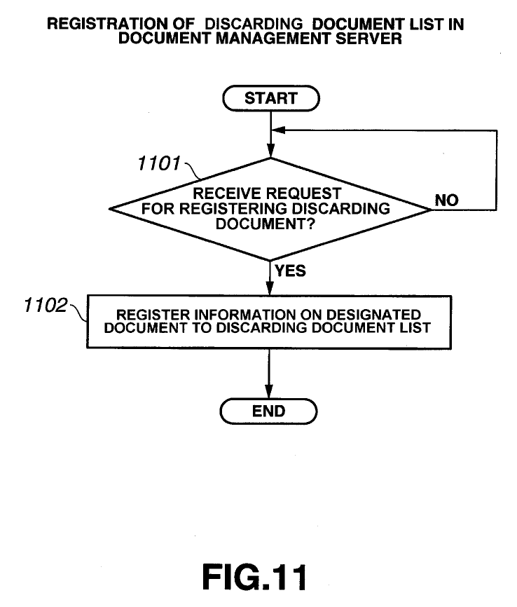

FIG. 11 is an example of a flowchart showing a flow of registration process in which the document management server performs registration to the discarding document list in response to the request for discarding processing from the client PC shown in FIG. 10.

Upon receiving a request for discarding processing from the client PC (YES in 1101), the document management server registers the designated document to the discarding document list (1102). The document in this discarding document list is to be discarded.

In the discarding document list, the document ID that identifies the document designated as being discarded is designated, and the document to be discarded is identified with reference to the history of operations based on the document ID.

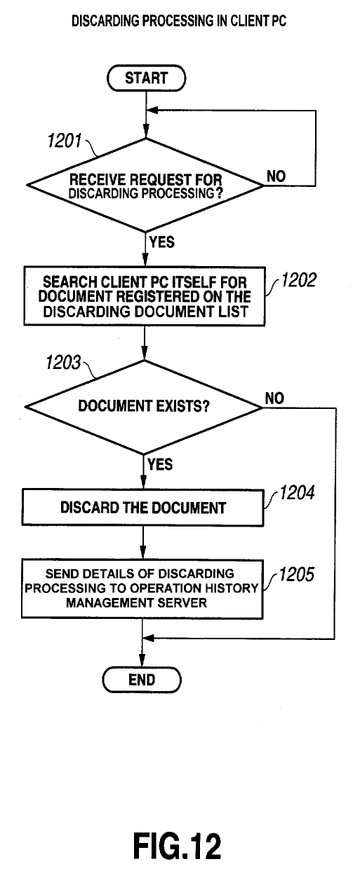

FIG. 12 is an example of a flowchart showing a process flow for discarding a document indicated on a discarding document list in a document management server.

In FIG. 12, upon receiving a request for the discarding process (1201), the client PC searches the client PC itself for the document indicated on the discarding document list included in the request for the discarding process (1202).

With this searching process, it is determined whether the document indicated on the discarding document list exists (1203). When the document does not exist (NO in 1203), the process ends because the discarding process cannot be implemented.

On the other hand, when the designated document exists on the discarding document list (YES in 1203), the process of discarding the document is implemented (1204). After the discarding process is implemented, the history information on the discarding process is sent to the operation history management server (1205).

It should be noted that the document discarding process system that implements the process as described above may be configured so as to cause the document discarding process system having a communication function to implement the above-described operation, or to install a program for configuring the above-described means from the recording medium (CD-ROM, DVD-ROM, etc.) storing this program and implementing the program. Through a system bus, a CPU (Central Processor Unit), a ROM (Read Only Memory), a RAM (Read Access Memory), and a hard disk are connected to the computer that makes up the document discarding process system. The CPU operates in accordance with a program stored in the ROM or the hard disk, and processes using the RAM as a work area.

Additionally, the medium for supplying the program may be a communication medium (communication line, or medium for temporarily or dynamically maintaining the program similar to the communication system). For example, it may be configured by posting the program on the BBS (Bulletin Board Service) on the communication network, and distributing the program through the communication lines.

The present invention is not limited to the example described above and shown in the figures, and may also be implemented by modifying as appropriate within the scope not changing the gist of the present invention.

### SECOND EXAMPLE

In the Second Example, an example case where the Bloom Filter is used in the configuration shown in the First Example as the discarding document list designating the document to be discarded is shown.

In the First Example, the identification information that is uniquely managed as the identification information that identifying the document or the hash value is used, the discarding document list indicating this identification information is distributed to each of the client PCs, whereby the document that matches the identification information is discarded. On the other hand, in the Second Example, the Bloom Filter is created from the identification information, and the created Bloom Filter is distributed to each of the client PCs as the discarding document list, whereby the document represented by the Bloom Filter is discarded.

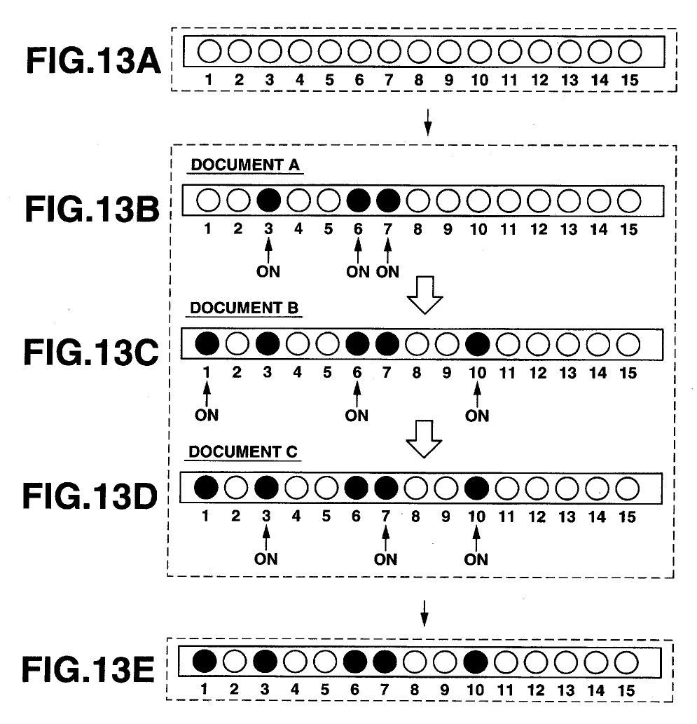

FIGS. 13A through 13E are diagrams showing an example of the discarding document list using the Bloom Filter.

The Bloom Filter is a group of calculated values with the hash values obtained by applying plural hash functions to prescribed data, and is represented by a structure as shown in FIG. 13A.

The Bloom Filter shown in FIG. 13A is formed with bit positions ranging from “1” to “15”, and each of the hash values calculated by applying the plural hash functions to the identification information of the document designated as being discarded is allocated to each of the bit positions.

FIGS. 13B through 13D show the Bloom Filters in states where, after hash values for documents A, B, C are calculated using three hash functions (e.g. “hash 1”, “hash 2” and “hash 3”), those hash values are allocated to each of the corresponding bit positions.

Firstly, FIG. 13B shows a state where the hash values calculated by applying the three hash functions to the identification information identifying the “document A” are allocated to the bit positions of “3”, “6” and “7”. Next, under this state where the hash values are allocated to the bit positions, a state where the hash values calculated by applying the three hash functions to the identification information of the “document B” are allocated to the bit positions of “1”, “6” and “10” is shown in FIG. 13C.

In this state, since the bit position of “6” is already allocated at the time of the document A, only the bit positions that do not overlap are allocated. In other words, the logical OR is applied to each of the bit positions.

Additionally, under the state where the bit positions are allocated for the “document A” and the “document B”, the hash values calculated by applying the three hash functions to the identification information of the “document C” are allocated to the bit positions of “3”, “7” and “10”. Similarly, the logical OR is applied to each of the bit positions. Specifically, since the bit positions of “3”, “7” and “10” are already allocated as shown in FIG. 13C, the bit positions corresponding to the hash values calculated from the “document C” are not allocated any more.

With the process as described above, the Bloom Filter as shown in FIG. 13E is created. The Bloom Filter as shown in FIG. 13E is distributed to each of the client PC as the discarding document list.

Since the Bloom Filter created as described above is created using the logical OR of the bit positions, the Bloom Filter has a stochastic data structure. Thus, when the Bloom Filter is received as the discarding document list, and there exists a document having a bit position that matches with the bit position of the received Bloom Filter, the Bloom Filter as created above only represents that there is a possibility that the document is a document to be discarded, and does not indicate that the document is the document to be discarded.

On the other hand, when the document has a bit position not matching with the bit position of the received Bloom Filter, this shows that this document is not a document designated as being discarded.

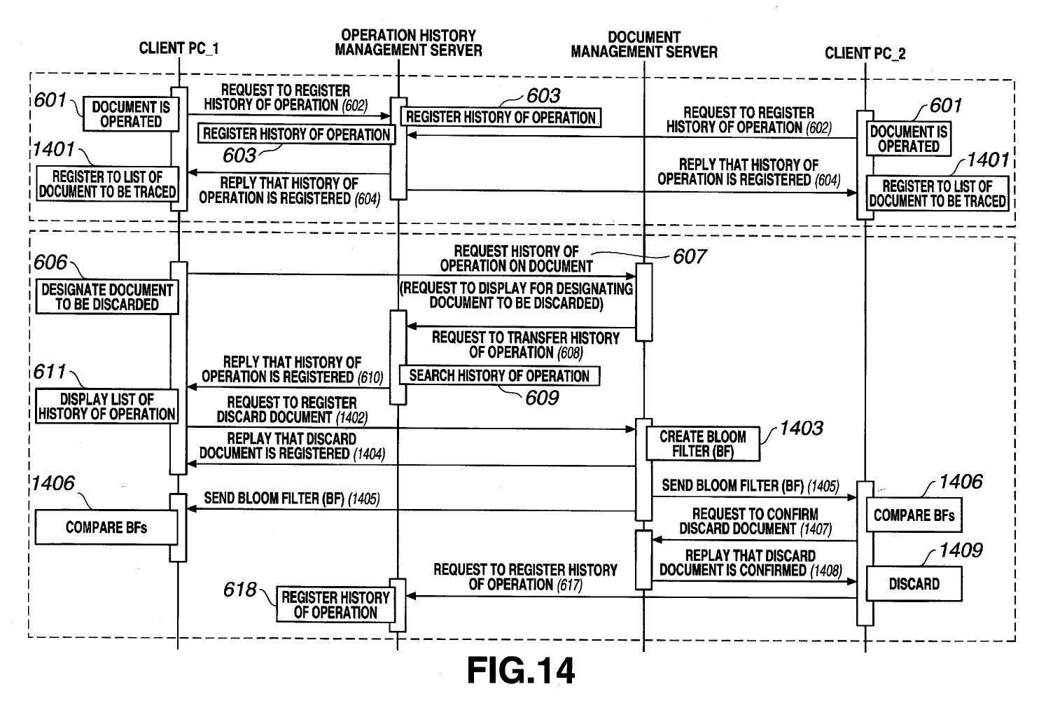

FIG. 14 shows a transition of the process of the document discarding process system at this time.

Since the transition of the process shown in FIG. 14 is similar to the transition of the process shown in FIG. 6, a description will be made primarily of the differences.

When the document is operated by the client PC 1 or client PC 2 (601) and the history of operation is managed in the operation history management server (603), upon receiving the reply (604), the document is registered to a list of document to be traced (1401). The list of document to be traced is configured with the Bloom Filter, and the document is registered to the Bloom Filter using identification information of the document to be traced. In other words, the bit positions corresponding to the identification information is allocated. Needless to say, if the document is already registered, re-registration is not implemented.

Next, when, under the state where the list of history of operation of the document to be discarded is displayed (611), the document to be discarded is selected and request for registering to the discarding document list is made (1402), the document management server that receives the request for registration creates the Bloom Filter in which the bit positions corresponding to the document are allocated (1403).

It should be noted that, in the Second Example, a description will be made of the Bloom Filter with the length of 16 bit (2 byte) for the sake of simplicity. However, longer Bloom Filter may be used in accordance with the number of the discard document to be identified.

Furthermore, after the prescribed time period elapses from the Bloom Filter being registered, or after the Bloom Filter is created, the document management server distributes the created Bloom Filter to each of the client PCs (client PC 1, client PC 2) (1405).

The client PC that receives the Bloom Filter as the discarding document list compares the received Bloom Filter with a Bloom Filter that is a list of the document to be traced, and determines whether the document designated as being discarded exists (1406).

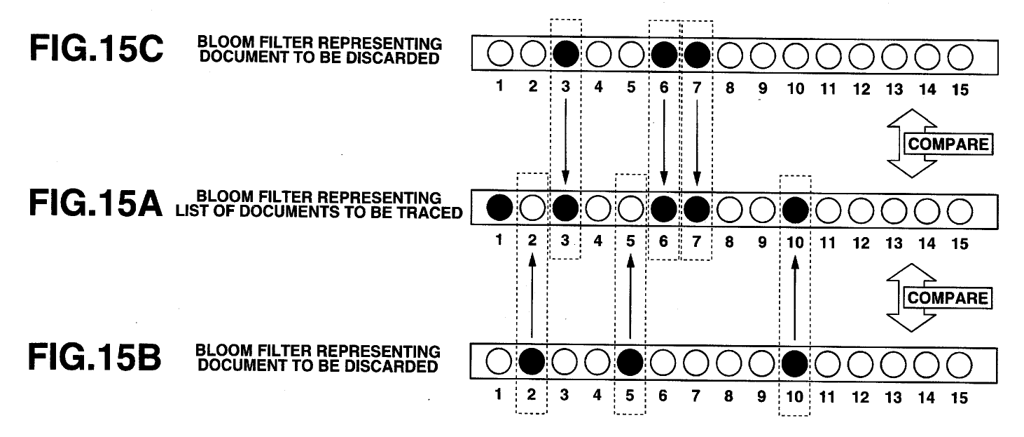

For example, when the Bloom Filter as shown in FIG. 15B is received as the discarding document list under a state where the Bloom Filter as shown in FIG. 15A is managed as the list of the document to be traced, it is determined that the document designated as being discarded does not exist in the client PC since each of the Bloom Filters does not match in at least three bit positions that is the number of the applied hash functions.

On the other hand, when the Bloom Filter as shown in FIG. 15C is received as the discarding document list, it is determined that there is a possibility that the document designated as being discarded exists in the client PC since each of the Bloom Filters matches in at least three bit positions that is the number of the applied hash functions.

In the Bloom Filter shown in FIG. 15A, “1”, “3”, “6”, “7” and “10” are allocated as the bit positions, while, in the Bloom Filter shown in FIG. 15B, “2”, “5” and “10” are allocated as the bit positions. Thus, only bit position of “10” overlaps. Since each of the Bloom Filters matches in less than three bit positions that are the number of the applied hash functions, the document in the client PC is not a document to be discarded.

On the other hand, in the Bloom Filter shown in FIG. 15C, “3”, “6” and “7” are allocated to the bit positions. Thus, those bit positions overlap all the bit positions of the Bloom Filter shown in FIG. 15A. Since each of the Bloom Filter matches in at least three bit positions that are the number of the applied hash functions, there is a possibility that the client PC has the document to be discarded.

As described above, it is determined whether the client PC has the document to be discarded (1406). When there is a possibility that the client PC has, it is confirmed to the document management server whether the document having the matched bit positions is the discard target document (1407). When determining that the document is included in the documents used to create the Bloom Filter, the document management server notifies the client PC that the document to be confirmed is the document to be discarded (1408). When not included, the document management server notifies the client PC that the document to be confirmed is not the document to be discarded (1408).

Next, when the discard document is identified, the document is discarded (1409), the client PC that discard the document requests the operation history management server to register the history of the operation (617), and the operation history management server manages as the discarding process history (618).

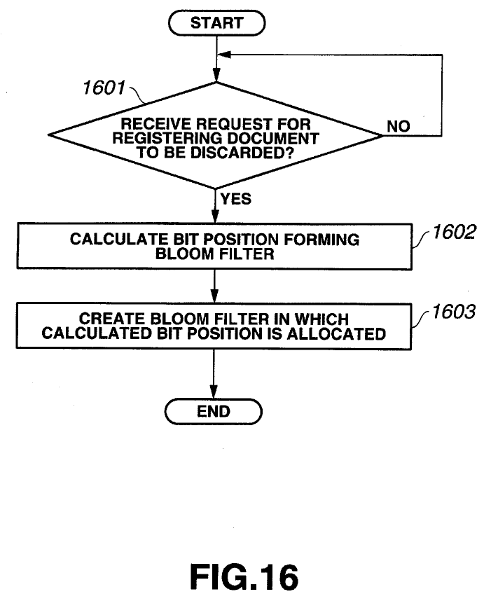

With reference to FIGS. 16 through 18, a process flow of searching a document using the Bloom Filter as described above will be described in detail.

FIG. 16 is an example flowchart showing a process flow of creating a Bloom Filter in the document management server based on the Bloom Filter.

Upon receiving from the client PC a request for discarding a document (YES in 1601), a hash value for a bit position is calculated by applying a prescribed hash function to the document for which the discarding process is requested (1602).

Then, a Bloom Filter in which the calculated bit positions are allocated is created as the discarding document list (1603).

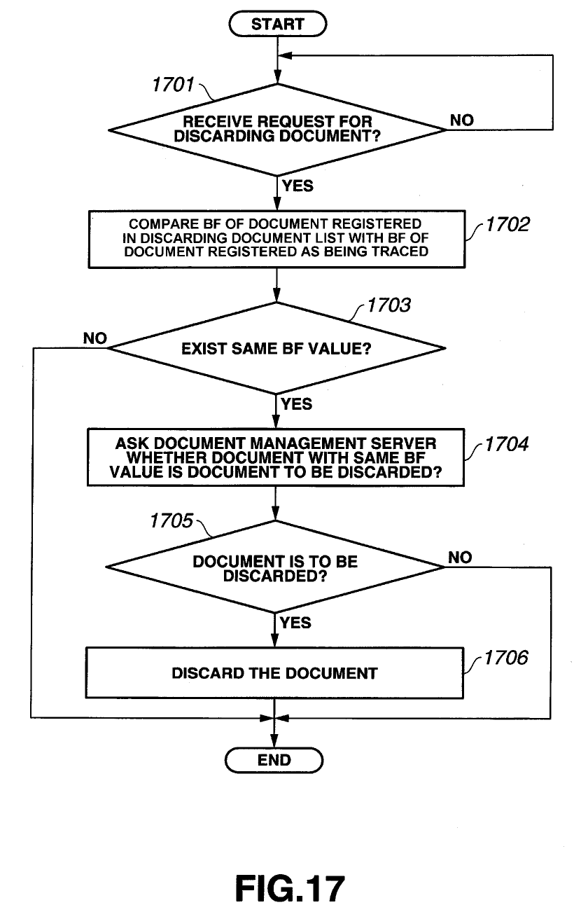

Next, FIG. 17 is an example of a flowchart showing a process flow of discarding in the client PC.

Upon receiving a request for discarding (YES in 1701), the client PC compares a Bloom Filter representing a discarding document list included in the request for discarding with the Bloom Filter for the document to be traced stored in the client PC (1702). Based on the comparison result, it is determined whether the bit positions of both of the Bloom Filter match each other and the matched bit positions are the number of the applied hash functions or more (1703).

When it is determined that the number of the matched bit positions are less than the number of the applied hash functions (NO in 1703), the process ends because the document to be discarded does not exist in the client PC. On the other hand, when it is determined that the number of the matched bit positions are the number of the applied hash functions or more (YES in 1703), it is determined that there is a possibility that the document represented by the matched bit positions is a document to be discarded, and the client PC makes an inquiry, by sending the document ID of the document, to the document management server whether the represented document is a document to be discarded (1704).

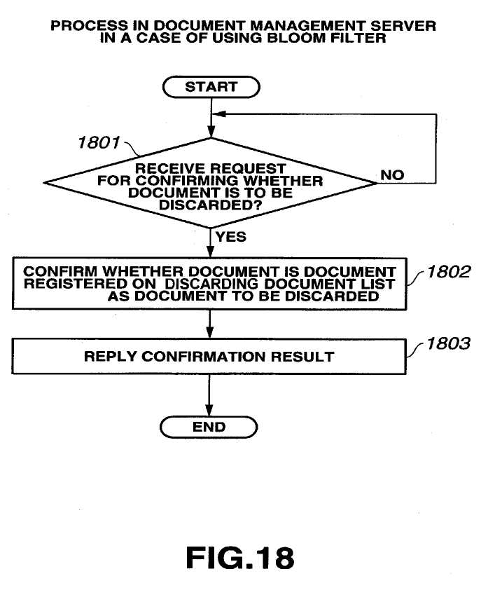

Then, the document management server determines whether the document with the document ID is the document to be discarded (a process as shown in FIG. 18), and sends the determined result to the client PC. The client PC receives the determined result, and determines, using the result, whether the document is to be discarded (1705). When the document is to be discarded (YES in 1705), the document is discarded (1706). When the document is not to be discarded (NO in 1705), the process ends.

FIG. 18 shows an example of a flowchart in which the document management server determines whether the document is to be discarded. Upon receiving from the client PC that distributes the Bloom Filter a request for determining whether the document is to be discarded (1801), the document management server determines, using the document ID included in the received request for determination, whether the document is the document from which the Bloom Filter, which is the discarding document list, is created (1802). Then, the document management server returns the determination result to the client PC (1803).

In other words, when the document ID corresponding to the document included in the request for determination matches the document ID of the document designated in the discarding document list, the document represented by the document ID is the document to be discarded, and the document management server returns the client PC to that effect.

### THIRD EXAMPLE

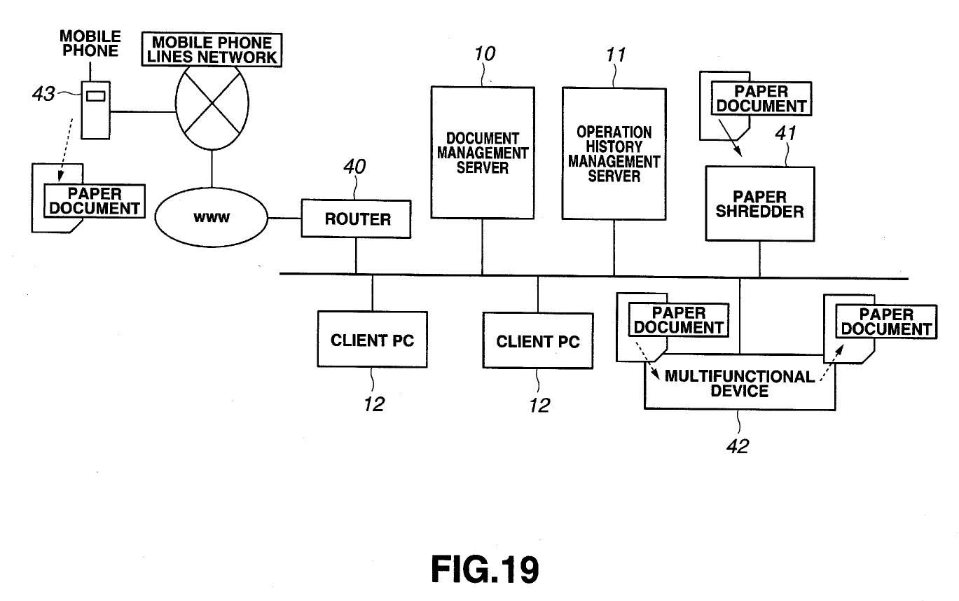

FIG. 19 is a diagram showing a configuration in which a router 40, a paper shredder 41, a multifunctional device 42 and a mobile terminal 43 (hereinafter referred to as “mobile phone 43”) is connected to the configuration with the document management serve 10, the operation history management server 11, the client PC 1 (12-1) and the client PC 2 (12-2) shown in FIG. 1.

The multifunctional device 42 outputs a printed matter to which a two-dimensional bar code is attached based on the printing request from the client PC 1 (12-1) or the client PC 2 (12-2). The multifunctional device 42 has a scan device for reading the two-dimensional bar code attached to the printed matter.

The two-dimensional bar code attached to the printed matter is one example of a symbol showing prescribed information. Thus, the symbol is not limited to the two-dimensional bar code. The symbol capable of representing the prescribed information such as a character string and a one-dimensional bar code may be applicable to the present invention.

The Third Example provides a process in which the document represented by the two-dimensional bar code on the printed matter outputted by the multifunctional device 42 is identified and discarded.

For a reading device for reading the two-dimensional bar code attached to the printed matter outputted by the multifunctional device 42, there are the paper shredder 41, the mobile phone 43 and the multifunctional device 42. Each of those devices has a code reader, and discards a document represented by the bar code read by the code reader.

A request for the history of operations for the document represented by the read two-dimensional bar code is made to the document management server 10. In this request, the document ID for identifying the document is designated. As information for identifying the document, the Bloom Filter as shown in the Second Example may be used.

The document management server 10 that receives the request for the history of operations requests the operation history management server 11 to display a list of the history of operations of the document. The operation history management server 11 that receives the request for displaying the list searches the history of operations of the document, and replies to the code reader that is a requester and that reads the two-dimensional bar code.

For example, when the mobile phone 43 reads the two-dimensional bar code attached to the printed matter and makes a request for displaying a list of the history of operations of the document, the history of operations searched by the operation history management server 11 is caused to be shown on the display of the mobile phone 43.

The mobile phone 43 that displays the list of the history of operation performs similar process by the client PC 12 as described in the First and the Second Examples, and discards the designated document.

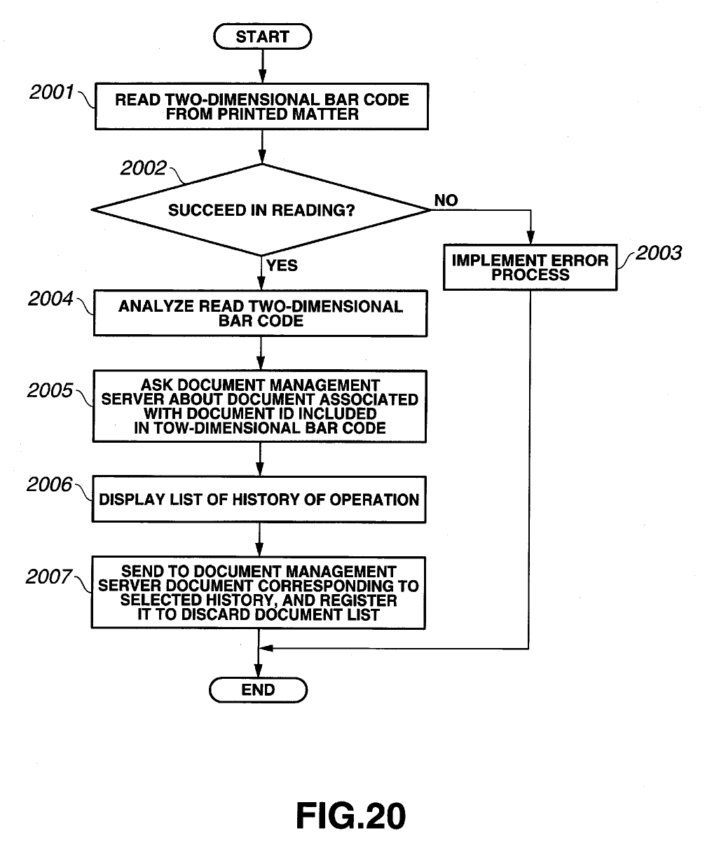

FIG. 20 is a flowchart showing a process flow performed by the paper shredder 41, the mobile phone 43 or the multifunctional device 42 of the code reader.

In FIG. 20, the two-dimensional bar code attached to the printed matter is read using the code reader of the paper shredder 41, the mobile phone 43 or the multifunction device 42 (2001), and it is determined whether the two-dimensional bar code is appropriately read (2002). This two-dimensional bar code includes identification information for identifying a printed document at the time of printing out by the multifunctional device.

When it is determined that the bar code is not appropriately read as a result of the determination described above (NO in 2002), the error process of displaying to that effect is performed and the process ends (2003).

On the other hand, when it is determined that the two-dimensional bar code is appropriately read (YES in 2002), the read two-dimensional bar code is analyzed to read the identification information for identifying the document (2004). Next, an inquiry for the document associated with the read identification information is made to the document management server (2005).

At this time, the document management server requests the history of operations corresponding to the designated document from the operation history management server. The operation history management server that receives the request returns the history of operations of the designated document to the requestor that reads the two-dimensional bar code. Through this process, the list of the history of operations is displayed on the display of the requestor (2006).

Then, the history of operations of the document to be discarded is selected from the displayed history of operations, and is registered to the discarding document list through the process of requesting the document management server to discard (2007).

The foregoing description of the exemplary embodiments of the present invention is provided for the purposes of illustration and description. It is not intended to be exhaustive or to limit the invention to the precise forms disclosed. Obviously, many modifications and variations will be apparent to practitioners skilled in the art. The exemplary embodiments were chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. A document discarding process system including:
a discard document management device that registers and manages a discard target document to be discarded; and
at least one document processing device that is connected to the discard document management device through a communication section,
the discard document management device comprising:
an accepting section that accepts a registration of the discard target document;
a registering section that registers the discard target document that is accepted by the accepting section; and
a distributing section that distributes identification information for identifying the discard target document registered by the registering section through the communication section to the at least one document processing device, and
the at least one document processing device comprising:
a receiving section that receives the identification information distributed by the distributing section;
a searching section that searches the discard target document based on the identification information received by the receiving section; and
a discarding section that discards the discard target documents searched by the searching section.

2. The document discarding process system according to claim 1, further comprising:
an operation history management device that manages a history of operation of a document operated by the at least one document processing device,
the discard document management device further comprising:
an identifying section that identifies a document associated with the discard target document accepted by the accepting section from the history of operation of the discard target document managed by the operation history management device, wherein
the registering section registers the document associated with the discard target document and identified by the identifying section as the discard target document.

3. The document discarding process system according to claim 1, wherein,
at the time when a new discard target document is accepted by the accepting section, the distributing section distributes the identification information for identifying the discard target document through the communication section to the at least one document processing device.

4. The document discarding process system according to claim 2, wherein,
at the time when a new discard target document is accepted by the accepting section, the distributing section distributes the identification information for identifying the discard target document through the communication section to the at least one document processing device.

5. The document discarding process system according to claim 1, wherein
the distributing section distributes the identification information for identifying the discard target document through the communication section to the at least one document processing device every time when a prescribed time period elapses.

6. The document discarding process system according to claim 2, wherein
the distributing section distributes the identification information for identifying the discard target document through the communication section to the at least one document processing device every time when a prescribed time period elapses.

7. The document discarding process system according to claim 1, wherein,
at the time when a new document processing device is connected to the communication section, the distributing section distributes the identification information for identifying the discard target document through the communication section to the at least one document processing device.

8. The document discarding process system according to claim 2, wherein,
at the time when a new document processing device is connected to the communication section, the distributing section distributes the identification information for identifying the discard target document through the communication section to the at least one document processing device.

9. The document discarding process system according to claim 1, wherein
the distributing section applies a prescribed calculation process to the discard target document registered by the registering section, calculates a value uniquely identifying the discard target document, and distributes, as the identification information, the calculated value through the communication section to the document processing device.

10. The document discarding process system according to claim 2, wherein
the distributing section applies a prescribed calculation process to the discard target document registered by the registering section, calculates a value uniquely identifying the discard target document, and distributes, as the identification information, the calculated value through the communication section to the document processing device.

11. The document discarding process system according to claim 1, further comprising a reading section that reads document identification information printed on a printed matter that is printed out, wherein
the registering section registers a document corresponding to the document identification information read by the reading section to the discard target document.

12. The document discarding process system according to claim 2, further comprising a reading section that reads document identification information printed on a printed matter that is printed out, wherein
the registering section registers a document corresponding to the document identification information read by the reading section to the discard target document.

13. The document discarding process system according to claim 2, wherein
the identifying section extracts from the history of operation managed by the operation history management device a document derivatively created from the discard target document, and identifies as a document associated with the discard target document.

14. The document discarding process system according to claim 2, wherein
the identifying section extracts from the history of operation managed by the operation history management device a document derivatively created from the discard target document, and identifies a document selected from the extracted document as a document associated with the discard target documents.

15. The document discarding process system according to claim 1,
the discard document management device further comprising:
a first calculation value group generating section that calculates, by a prescribed calculation, a first calculation value group corresponding to the discard target document, wherein
the distributing section distributes, as the identification information, the first calculation value group calculated by the first calculation value group generating section through the communication section to the at least one document processing device, and
the at least one document processing device further comprising:
a second calculation value group generating section that calculates, by a prescribed calculation, a second calculation value group corresponding to a document stored in the at least one document processing device, wherein
the searching section comprises a determining section that compares the first calculation value group and the second calculation value group to determine whether the discard document is stored in the at least one document processing device.

16. The document discarding process system according to claim 2,
the discard document management device further comprising:
a first calculation value group generating section that calculates, by a prescribed calculation, a first calculation value group corresponding to the discard target document, wherein
the distributing section distributes, as the identification information, the first calculation value group calculated by the first calculation value group generating section through the communication section to the at least one document processing device, and
the at least one document processing device further comprising:
a second calculation value group generating section that calculates, by a prescribed calculation, a second calculation value group corresponding to a document stored in the at least one document processing device, wherein
the searching section comprises a determining section that compares the first calculation value group and the second calculation value group to determine whether the discard document is stored in the at least one document processing device.

17. The document discarding process system according to claim 1, wherein,
at the time when the searching section does not perform the search for a prescribed time period, the discarding section discards a document stored in the at least one document processing device.

18. The document discarding process system according to claim 2, wherein,
at the time when the searching section does not perform the search for a prescribed time period, the discarding section discards a document stored in the at least one document processing device.

19. A discard document management device, comprising:
an accepting section that accepts a registration of a discard target document to be discarded;
a registering section that registers the discard target document accepted by the accepting section; and
an instructing section that distributes identification information for identifying the discard target document registered by the registering section through the communication section to at least one document processing device, and instructs to discard the discard target document identified by the identification information stored in the at least one document processing device.

20. The discard document management device according to claim 19, further comprising
an identifying section that identifies a document associated with the discard target document accepted by the accepting section from a history of operation of the discard target document in an operation history management device that manages the history of operation of document operated by the at least one document processing device, wherein
the registering section registers, as a discard target document, the document associated with the discard target document and identified by the identifying section.

21. A document processing device, comprising:
a receiving section that receives identification information for identifying a discard target document distributed by the discard document management device;
a searching section that searches the discard target document based on the identification information received by the receiving section; and
a discarding section that discards the discard target document searched by the searching section.

22. A document discarding processing method, comprising:
accepting a registration of a discard target document;
registering the accepted discard target document;
distributing identification information for identifying the registered discard target document;
receiving the distributed identification information;
searching the discard target document based on the received identification information; and
discarding the searched discard target document.

23. A computer readable recording medium storing a document discarding processing program for causing a computer to execute a process, the process comprising:
accepting registration of a discard target document to be discarded;
registering the accepted discard target document;
distributing identification information for identifying the registered discard target document through a communication section; and
instructing to discard the discard target document identified based on the stored identification information.
